(19) United States
(12) Patent Application Publication
(10) Pub. No.: US 2008/0225248 A1
(43) Pub. Date: Sep. 18, 2008

(54) Apparatus, systems and methods for removing liquid from workpiece during workpiece processing

(75) Inventors: Alex Ka Tim Poon, San Ramon, CA (US); Leonard Wai Fung Kho, San Francisco, CA (US); Gaurav Keswani, Fremont, CA (US); Derek Coon, Redwood City, CA (US)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/073,865

(22) Filed: Mar. 11, 2008

Related U.S. Application Data
(60) Provisional application No. 60/918,056, filed on Mar. 15, 2007.

(51) Int. Cl. G03B 27/42; G03B 27/52

(52) U.S. Cl. 355/30; 355/53

(57) ABSTRACT

Apparatus, systems and methods remove liquid from a workpiece. A first station subjects a workpiece to processing that leaves a liquid on a surface of the workpiece. A second station is disposed at a location spaced apart from the first station. A porous member is disposed between the first and second stations. The porous member has a liquid-phyllic surface that faces the workpiece and is spaced from a surface of the workpiece by a gap. The porous member has a length in a direction perpendicular to a movement direction in which the workpiece moves from the first station to the second station, the length being at least as large as a dimension of the workpiece in the direction perpendicular to the movement direction.

This application claims the benefit of U.S. Provisional Application No. 60/918,056 filed Mar. 15, 2007. The disclosure of the provisional application is incorporated herein by reference in its entirety.

### BACKGROUND

Lithography systems are commonly used to transfer images from a reticle onto a semiconductor wafer during semiconductor processing. A typical lithography system includes an optical assembly, a reticle stage for holding a reticle defining a pattern, a wafer stage assembly that positions a semiconductor wafer, and a measurement system that precisely monitors the position of the reticle and the wafer. During operation, an image defined by the reticle is projected by the optical assembly onto the wafer. The projected image is typically the size of one or more die on the wafer. After an exposure, the wafer stage assembly moves the wafer and then another exposure takes place. This process is repeated until all the die on the wafer are exposed. The wafer is then removed and a new wafer is exchanged in its place.

Immersion lithography systems utilize a layer of immersion liquid that fills a space between the optical assembly and the wafer during the exposure of the wafer. The optic properties of the immersion liquid, along with the optical assembly, allow the projection of smaller feature sizes than is currently possible using standard optical lithography. For example, immersion lithography is currently being considered for semiconductor technologies including those beyond 45 nanometers. Immersion lithography therefore represents a significant technological breakthrough that enables the continued use of optical lithography.

After a wafer is exposed, it is removed and exchanged with a new wafer. As contemplated in some immersion systems, the immersion liquid would be removed from the space and then replenished after the wafer is exchanged. More specifically, when a wafer is to be exchanged, the liquid supply to the space is turned off, the liquid is removed from the space (i.e., by vacuum), the old wafer is removed, a new wafer is aligned and placed under the optical assembly, and then the space is re-filled with fresh immersion liquid. Once all of the above steps are complete, exposure of the new wafer can begin. In a tandem (or twin) stage immersion lithography system, a pair of stages are provided, with the stages being alternately positioned under the optical assembly while wafer exchange and/or alignment is performed on the wafer stage not disposed under the optical assembly. When the exposure of the wafer under the optical assembly is complete, the two stages are swapped and the process is repeated. Examples of such exposure apparatus are disclosed in U.S. Pat. No. 6,341,007 and in U.S. Pat. No. 6,262,796, the disclosures of which are incorporated herein by reference in their entireties.

Wafer exchange with immersion lithography as described above continues to be problematic for a number of reasons. After exposure is completed, a thin film of liquid can remain on the wafer even after the bulk of the immersion liquid is removed. The thin film of liquid can form droplets on the wafer surface and/or on the upper surface of the wafer stage. During wafer alignment check and wafer unloading, the wafer stage has to travel a long distance at a high speed to maximize machine throughput. The liquid droplets can be flung off the wafer surface and/or the stage surface when the wafer stage moves at high speed, for a long distance, or if the immersion liquid has a low contact angle on the substrate. The scattering of liquid droplets in the machine can cause undesirable fluctuations in the humidity and temperature of the machine's internal environment.

### SUMMARY

Apparatus, systems and methods for removing immersion liquid from a workpiece, for example during workpiece exchange and/or during long fast moves, are therefore desirable. Aspects of the apparatus, systems and methods disclosed herein minimize the overhead time to remove immersion liquid left on a workpiece during workpiece exchange and/or during long fast moves, so that these operations can be carried out without contaminating the machine with liquid droplets. As a result, machine throughput can be increased.

Systems include a first station at which a workpiece is subjected to processing that may leave a liquid on a surface of the workpiece, and a second station disposed at a location spaced apart from the first station. A porous member is disposed between the first and second stations, and has a liquid-phyllic surface that faces the workpiece and is spaced from a surface of the workpiece by a gap. The porous member has a length in a direction perpendicular to a movement direction in which the workpiece moves from the first station to the second station. The porous member length is at least as large as a dimension of the workpiece in the direction perpendicular to the movement direction.

Apparatus include an optical assembly that projects an image onto a workpiece and a stage assembly including a workpiece table that supports the workpiece adjacent to the optical assembly. An environmental system supplies and removes immersion liquid to and from a space between the workpiece and the optical assembly. A workpiece exchange station is disposed at a location that is spaced away from the optical assembly. A rotating cylinder having a liquid-phyllic surface is disposed in a path of movement of the stage assembly between the optical assembly and the workpiece exchange station. The rotating cylinder removes immersion liquid from a surface of the workpiece by rotating in a direction opposite to a direction of movement of the stage assembly when the stage assembly is moved from being disposed adjacent to the optical assembly towards the workpiece exchange station.

Other apparatus include an optical assembly that projects an image onto a workpiece and a stage assembly including a workpiece table that supports the workpiece adjacent to the optical assembly. An environmental system supplies and removes immersion liquid to and from a space between the workpiece and the optical assembly. A workpiece exchange station is disposed at a location that is spaced away from the optical assembly. A porous media is disposed in a path of movement of the stage assembly between the optical assembly and the workpiece exchange station. The porous media absorbs immersion liquid from a surface of the workpiece when the liquid comes into contact with the porous media when the stage assembly is moved from being disposed adjacent to the optical assembly towards the workpiece exchange station.

Methods include: processing a workpiece at a first station at which a liquid may be left on a surface of the workpiece, moving the processed workpiece from the first station to a second station disposed at a location spaced apart from the first station, removing the liquid left on the workpiece as the workpiece moves toward the second station, the removing being performed by a porous member disposed between the first and second stations, the porous member having a liquid-phyllic surface that faces the workpiece.

Further apparatus include an optical assembly that projects an image onto a workpiece, and a stage assembly including a workpiece table that supports the workpiece adjacent to the optical assembly. An environmental system supplies and removes immersion liquid to and from a space between the workpiece and the optical assembly. A plurality of rotating cylinders collectively surround the space so as to keep the immersion liquid from escaping from the space between the optical assembly and the workpiece at least during exposure operations.

### BRIEF DESCRIPTION OF THE DRAWINGS

The invention will be described in conjunction with the following drawings of exemplary embodiments in which like reference numerals designate like elements, and in which:

FIG. 1 is an illustration of a first station at which a workpiece is subjected to processing that leaves a liquid on a surface of the workpiece according to an embodiment of the invention;

FIGS. 2A and 2B are a cross section and a plan view, respectively, of a system that removes liquid from a workpiece during workpiece processing according to an embodiment of the invention;

FIG. 2C illustrates further details of the porous member of the system according to the embodiment of FIGS. 2A and 2B;

FIGS. 3A and 3B are a cross section and a plan view, respectively, of an immersion lithography machine according to another embodiment of the invention;

FIG. 3C illustrates further details of the rotating cylinder of the immersion lithography machine according to the embodiment of FIGS. 3A and 3B;

FIG. 4 is a cross section view of an immersion lithography machine according to a further embodiment of the invention;

FIGS. 5A and 5B are plan views of two different twin wafer stages according to other embodiments of the invention;

FIG. 6A is a flow chart that outlines a process for manufacturing a device in accordance with the invention; and

FIG. 6B is a flow chart that outlines device processing in more detail.

### DETAILED DESCRIPTION OF EMBODIMENTS

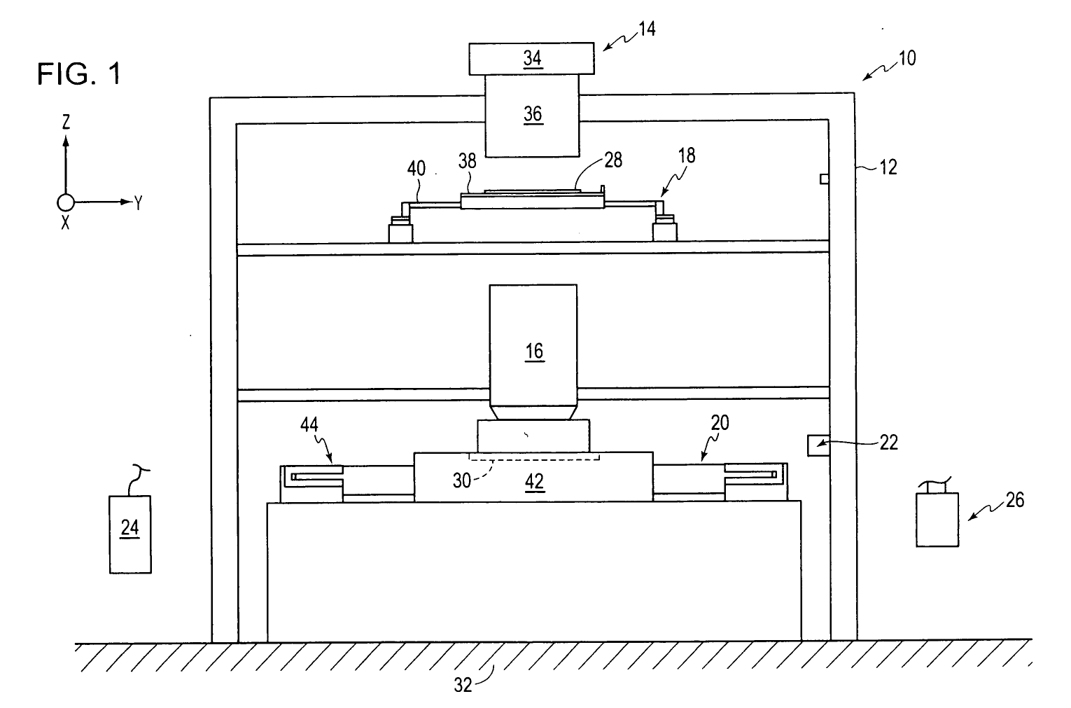

FIG. 1 is a schematic illustration of an exemplary first station at which a workpiece 30 is subjected to processing that may leave a liquid on a surface of the workpiece 30. In this example, the first station is an exposure station of a lithographic projection apparatus (or lithography machine) 10. However, the first station does not have to be part of a lithographic projection apparatus, and may be a station in any apparatus or device in which a workpiece is subjected to processing that may leave a liquid on a surface of the workpiece. The lithography machine 10 includes a frame 12, an illumination system 14 (irradiation apparatus), an optical assembly 16, a reticle stage assembly 18, a workpiece stage assembly 20, a measurement system 22, a control system 24, and a liquid environmental system 26. The design of the components of the lithography machine 10 can be varied to suit the design requirements of the lithography machine 10.

In one embodiment, the lithography machine 10 is used to transfer a pattern (not shown) of an integrated circuit from a reticle 28 onto the workpiece 30, such as a semiconductor wafer (illustrated in phantom). The lithography machine 10 mounts to a mounting base 32, e.g., the ground, a base, or floor or some other supporting structure.

The lithography machine 10 can be used as a scanning type photolithography system that exposes the pattern from the reticle 28 onto the workpiece 30 with the reticle 28 and the workpiece 30 moving synchronously. In a scanning type lithographic machine, the reticle 28 is moved perpendicularly to an optical axis of the optical assembly 16 by the reticle stage assembly 18, and the workpiece 30 is moved perpendicularly to the optical axis of the optical assembly 16 by the workpiece stage assembly 20. Exposure occurs while the reticle 28 and the workpiece 30 are moving synchronously.

Alternatively, the lithography machine 10 can be a step-and-repeat type photolithography system that performs exposure while the reticle 28 and the workpiece 30 are stationary. In the step and repeat process, the workpiece 30 is in a constant position relative to the reticle 28 and the optical assembly 16 during the exposure of an individual field. Subsequently, between consecutive exposure steps, the workpiece 30 is consecutively moved with the workpiece stage assembly 20 perpendicularly to the optical axis of the optical assembly 16 so that the next field of the workpiece 30 is brought into position relative to the optical assembly 16 and the reticle 28 for exposure. Using this process, the image on the reticle 28 is sequentially exposed onto the fields of the workpiece 30.

However, the use of the lithography machine 10 provided herein is not necessarily limited to a photolithography for semiconductor manufacturing. The lithography machine 10, for example, can be used as an LCD photolithography system that exposes a liquid crystal display pattern onto a rectangular glass plate or a photolithography system for manufacturing a thin film magnetic head. Accordingly, the term “workpiece” is generically used herein to refer to any device that may be patterned using lithography, such as but not limited to wafers or LCD substrates.

The apparatus frame 12 supports the components of the lithography machine 10. The apparatus frame 12 illustrated in FIG. 1 supports the reticle stage assembly 18, the workpiece stage assembly 20, the optical assembly 16 and the illumination system 14 above the mounting base 32.

The illumination system 14 includes an illumination source 34 and an illumination optical assembly 36. The illumination source 34 emits a beam (irradiation) of light energy. The illumination optical assembly 36 guides the beam of light energy from the illumination source 34 to the optical assembly 16. The beam illuminates selectively different portions of the reticle 28 and exposes the workpiece 30. In FIG. 1, the illumination source 34 is illustrated as being supported above the reticle stage assembly 18. Typically, however, the illumination source 34 is secured to one of the sides of the apparatus frame 12 and the energy beam from the illumination source 34 is directed to above the reticle stage assembly 18 with the illumination optical assembly 36.

The illumination source 34 can be, for example, a g-line source (436 nm), an i-line source (365 nm), a KrF excimer laser (248 nm), an ArF excimer laser (193 nm) or a F₂ laser (157 nm). Alternatively, the illumination source 34 can generate an x-ray.

The optical assembly 16 projects and/or focuses the light passing through the reticle 28 to the workpiece 30. Depending upon the design of the lithography machine 10, the optical assembly 16 can magnify or reduce the image illuminated on the reticle 28. The optical assembly 16 need not be limited to a reduction system. It also could be a 1× or greater magnification system.

Also, with an exposure substrate that employs vacuum ultraviolet radiation (VUV) of wavelength 200 nm or lower, use of a catadioptric type optical system can be considered. Examples of a catadioptric type of optical system are disclosed in U.S. Pat. No. 5,668,672, as well as U.S. Pat. No. 5,835,275. In these cases, the reflecting optical system can be a catadioptric optical system incorporating a beam splitter and concave mirror. U.S. Pat. No. 5,689,377 as well as Japanese Laid-Open Patent Application Publication No. 10-3039 also use a reflecting-refracting type of optical system incorporating a concave mirror, etc., but without a beam splitter, and also can be employed with this invention. The disclosures of the above-mentioned U.S. patents, as well as the Japanese Laid-Open patent application publication are incorporated herein by reference in their entireties.

The reticle stage assembly 18 holds and positions the reticle 28 relative to the optical assembly 16 and the workpiece 30. In one embodiment, the reticle stage assembly 18 includes a reticle stage 38 that retains the reticle 28 and a reticle stage mover assembly 40 that moves and positions the reticle stage 38 and reticle 28.

Each stage mover assembly 40, 44 (44 being for the workpiece) can move the respective stage 38, 42 with three degrees of freedom, less than three degrees of freedom, or more than three degrees of freedom. For example, in alternative embodiments, each stage mover assembly 40, 44 can move the respective stage 38, 42 with one, two, three, four, five or six degrees of freedom. The reticle stage mover assembly 40 and the workpiece stage mover assembly 44 can each include one or more movers, such as rotary motors, voice coil motors, linear motors utilizing a Lorentz force to generate drive force, electromagnetic movers, planar motors, or other force movers.

In photolithography systems, when linear motors (see U.S. Pat. No. 5,623,853 or 5,528,118 which are incorporated by reference herein in their entireties) are used in the workpiece stage assembly or the reticle stage assembly, the linear motors can be either an air levitation type employing air bearings or a magnetic levitation type using Lorentz force or reactance force. Additionally, the stage could move along a guide, or it could be a guideless type stage that uses no guide.

Alternatively, one of the stages could be driven by a planar motor, which drives the stage by an electromagnetic force generated by a magnet unit having two-dimensionally arranged magnets and an armature coil unit having two-dimensionally arranged coils in facing positions. With this type of driving system, either the magnet unit or the armature coil unit is connected to the stage base and the other unit is mounted on the moving plane side of the stage.

Movement of the stages as described above generates reaction forces that can affect performance of the photolithography system. Reaction forces generated by the workpiece stage motion can be mechanically transferred to the floor (ground) by use of a frame member as described in U.S. Pat. No. 5,528,100. Additionally, reaction forces generated by the reticle (mask) stage motion can be mechanically transferred to the floor (ground) by use of a frame member as described in U.S. Pat. No. 5,874,820. The disclosures of U.S. Pat. Nos. 5,528,100 and 5,874,820 are incorporated herein by reference in their entireties.

The measurement system 22 monitors movement of the reticle 28 and the workpiece 30 relative to the optical assembly 16 or some other reference. With this information, the control system 24 can control the reticle stage assembly 18 to precisely position the reticle 28 and the workpiece stage assembly 20 to precisely position the workpiece 30. The design of the measurement system 22 can vary. For example, the measurement system 22 can utilize multiple laser interferometers, encoders, mirrors, and/or other measuring devices.

The control system 24 receives information from the measurement system 22 and controls the stage assemblies 18, 20 to precisely position the reticle 28 and the workpiece 30. Additionally, the control system 24 can control the operation of the components of the environmental system 26. The control system 24 can include one or more processors and circuits.

The environmental system 26 controls the environment in a space (not shown) between the optical assembly 16 and the workpiece 30. The space includes an imaging field. The imaging field includes the area adjacent to the region of the workpiece 30 that is being exposed and the area in which the beam of light energy travels between the optical assembly 16 and the workpiece 30. With this design, the environmental system 26 can control the environment in the imaging field. The desired environment created and/or controlled in the space by the environmental system 26 can vary according to the workpiece 30 and the design of the rest of the components of the lithography machine 10, including the illumination system 14. For example, the desired controlled environment can be a liquid such as water. Alternatively, the desired controlled environment can be another type of fluid such as a gas. In various embodiments, the space may range from 0.1 mm to 10 mm in height between top surface of the workpiece 30 and the last optical element of the optical assembly 16.

In one embodiment, the environmental system 26 fills the imaging field and the rest of the space with an immersion liquid. The design of the environmental system 26 and the components of the environmental system 26 can be varied. In different embodiments, the environmental system 26 delivers and/or injects immersion liquid into the space using spray nozzles, electro-kinetic sponges, porous materials, etc. and removes the liquid from the space using vacuum pumps, sponges, and the like. The design of the environmental system 26 can vary. For example, the environmental system 26 can inject the immersion liquid at one or more locations at or near the space. Further, the environmental system 26 can assist in removing and/or scavenging the immersion liquid at one or more locations at or near the workpiece 30, the space and/or the edge of the optical assembly 16. For additional details on various environmental systems, see, for example, U.S. 2007/0046910 A1, U.S. 2006/0152697 A1, U.S. 2006/0023182 A1 and U.S. 2006/0023184 A1, the disclosures of which are incorporated herein by reference in their entireties.

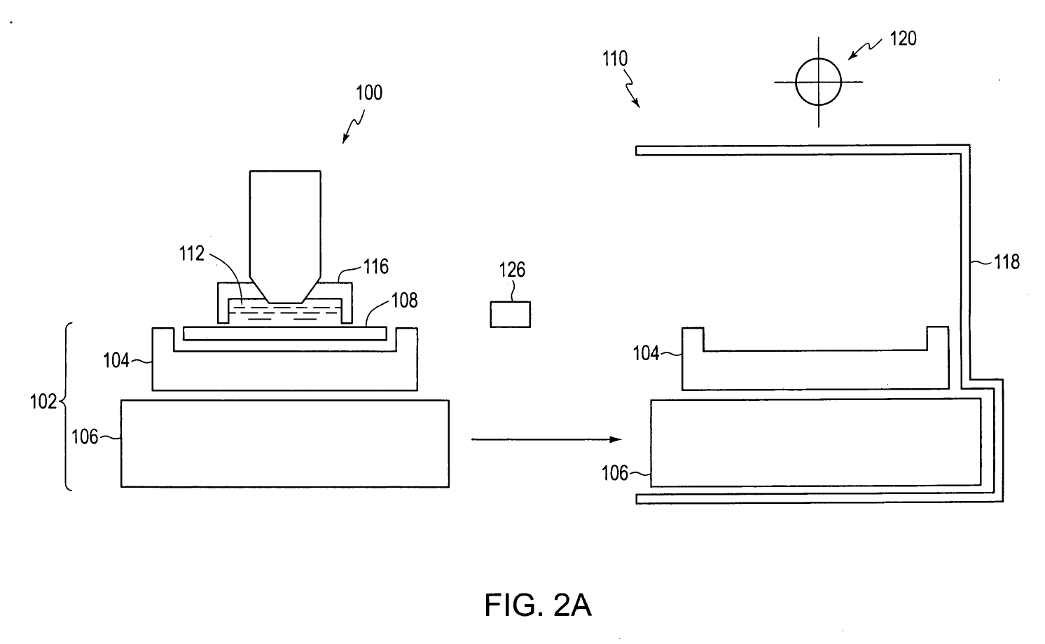

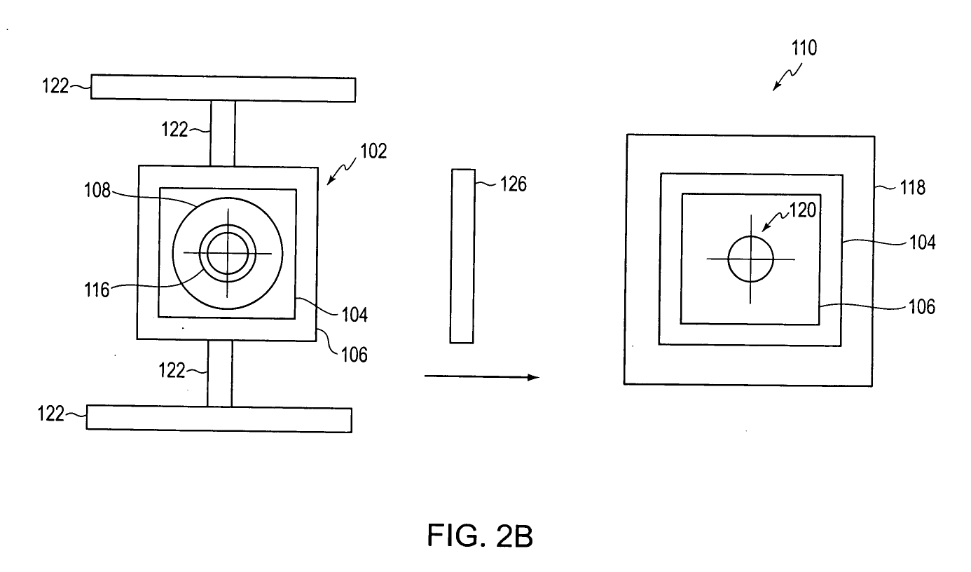

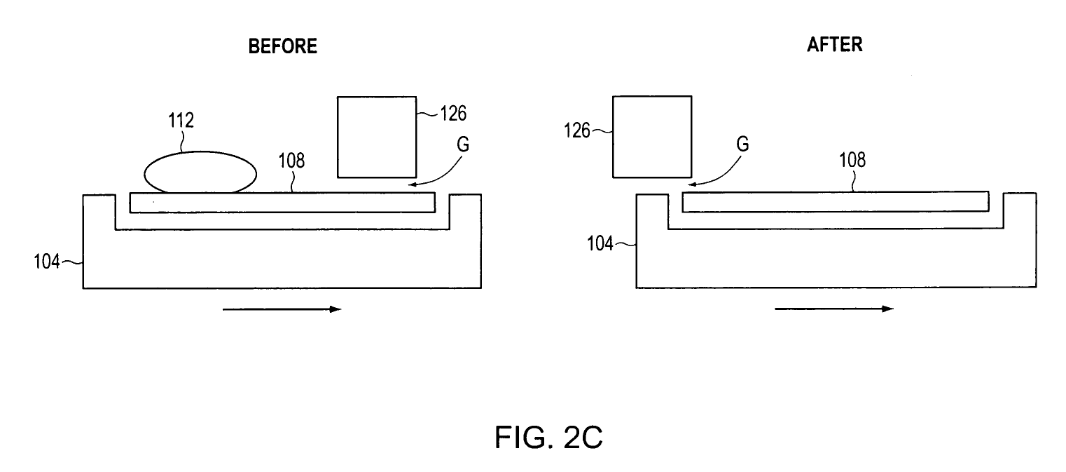

Referring to FIGS. 2A and 2B, a cross section and a plan (overhead) view of a system that removes liquid from a workpiece during workpiece processing are shown. The system includes a first station 100, at which liquid 112 is applied to a surface of a workpiece 108. The first station 100 includes an environmental system 116 and a stage assembly 102 that includes a workpiece table 104 and a workpiece stage 106. The workpiece table 104 is configured to support the workpiece 108 (or any other type of substrate) under the environmental system 116. The environmental system, 116 is used to supply and remove liquid 112 from the space between the workpiece 108 and the lowermost element of the environmental system 116 (which in this example includes a projection optical system). The system also includes a second station 110, as part of a workpiece exchange system that includes a workpiece loader 118 (i.e., a robot) and an alignment tool 120 (for example, a microscope and CCD camera). The second station 110 is disposed at a location spaced apart from the first station 100. The workpiece exchange system is configured to remove the workpiece 108 on the workpiece table 104 and replace it with a second workpiece on the workpiece table 104. This is typically accomplished using the workpiece loader 118 to remove the workpiece 108 from the workpiece table 104. That is, after the workpiece 108 has been processed at the first station, the stage assembly 102, including the workpiece table 104 holding the workpiece 108, moves from the first station 100 to the second station 110 where the processed workpiece 108 is removed from the workpiece table 104. Subsequently, a second workpiece (not shown) is placed onto the workpiece loader 118, aligned using the alignment tool 120, and then positioned under the environmental system 116 on the workpiece table 104. As best illustrated in FIG. 2B, a set of motors 122 is used to move the stage assembly 102 including the workpiece table 104 and workpiece stage 106 in up to six degrees of freedom (X, Y, Z, θₓ, θ_{y}, θ_{z}) during operation. As noted above, the motors 122 can be any type of motors, such as linear motors, rotary motors, voice coil motors, etc.

The system further includes a porous member 126 disposed between the first station 100 and the second station 110. The porous member 126 is configured to remove the liquid 112 left on the workpiece 108 and/or workpiece table 104 during workpiece exchange and/or during long fast moves of the stage assembly 102 from the first station 100 to the second station 110 so that these operations can be carried out without scattering liquid droplets. During processing of the workpiece 108 at first station 100, liquid 112 is continuously supplied by the environmental system 116 to the surface of workpiece 108, and is continuously recovered through the recovery element (not shown) of the environmental system 116. After processing at station 100 is completed, according to some embodiments, liquid is removed from environmental system 116. Alternatively, liquid could be maintained adjacent to the optical assembly 16 (e.g., with a cap or shutter), while liquid is removed from the workpiece 108. In order to perform a workpiece exchange, the workpiece table 104 is moved from the first station 100 to the second station 110 by moving from left-to-right in FIGS. 2A and 2B. This movement from the first station 100 to the second station 110 is performed as rapidly as possible to maintain a high throughput. However, inevitably, there is some liquid 112, for example in the form of liquid droplets, remaining on the workpiece 108 and/or workpiece table 104. To remove such remaining liquid, the porous member 126 according to the present embodiment is provided and has a liquid-phyllic surface that faces the workpiece 108 and is spaced from a top surface of the workpiece 108 by a small gap G (discussed below). Preferably, the porous member 126 is disposed close to the first station 100 so that liquid droplets are removed early in the traversal of the workpiece table 104 and workpiece 108 from the first station 100 to the second station 110.

As best illustrated in FIG. 2C, when the workpiece table 104 moves from the first station 100 to the second station 110, indicated by the arrows in FIGS. 2A-2C, the workpiece table 104 passes under the porous member 126. As the workpiece table 104 passes under the porous member 126, excess liquid 112 remaining on the surface of the workpiece 108 or on a surface of the workpiece table 104 is removed as the liquid contacts the liquid-phyllic surface of the porous member 126. Because no liquid 112 is left on the workpiece 108 or on a surface of the workpiece table 104, no liquid 112 will be scattered due to the movement of the workpiece stage assembly 102. Processes like workpiece unload/exchange and workpiece alignment can then be performed. After the new workpiece has been aligned using one or more alignment tools (not shown), the workpiece table 104 is repositioned under the environmental system 116 at the first station 100. Processing is then performed. In this manner, the porous member 126 removes the liquid 112 left on the workpiece 108 and/or workpiece table 104 during workpiece exchange and/or during long fast moves of the stage assembly 102 from the first station 100 to the second station 110.

The porous member 126 has a length in a direction perpendicular to a movement direction in which the workpiece 108 moves from the first station 100 to the second station 110. It is preferred that the length of the porous member 126 be at least as large as a dimension of the workpiece 108 in the direction perpendicular to the movement direction to ensure that the liquid-phyllic surface of the porous member 126 passes over the entire surface of the workpiece 108 that may have liquid droplets thereon to attract all of the liquid 112 on the surface of the workpiece 108. In the case where the workpiece 108 is circular, the length of the porous member 126 is at least as great as a diameter of the workpiece 108. Because the upper surface of the workpiece table 104 surrounding the workpiece 108 also may hold liquid droplets, it is preferable that the porous member length be sufficient to pass over all parts of the workpiece table 104 that may hold the droplets. As discussed above, the surface of the porous member 126 that faces the workpiece 108 is spaced from the surface of the workpiece 108 by a small gap G. The gap G may typically range from 100 microns to 1 mm. However, the gap G may be as small as 100 microns. Further, the porous member 126 may be of a ceramic, glass or metal material or alternatively may be of a mesh-metal material.

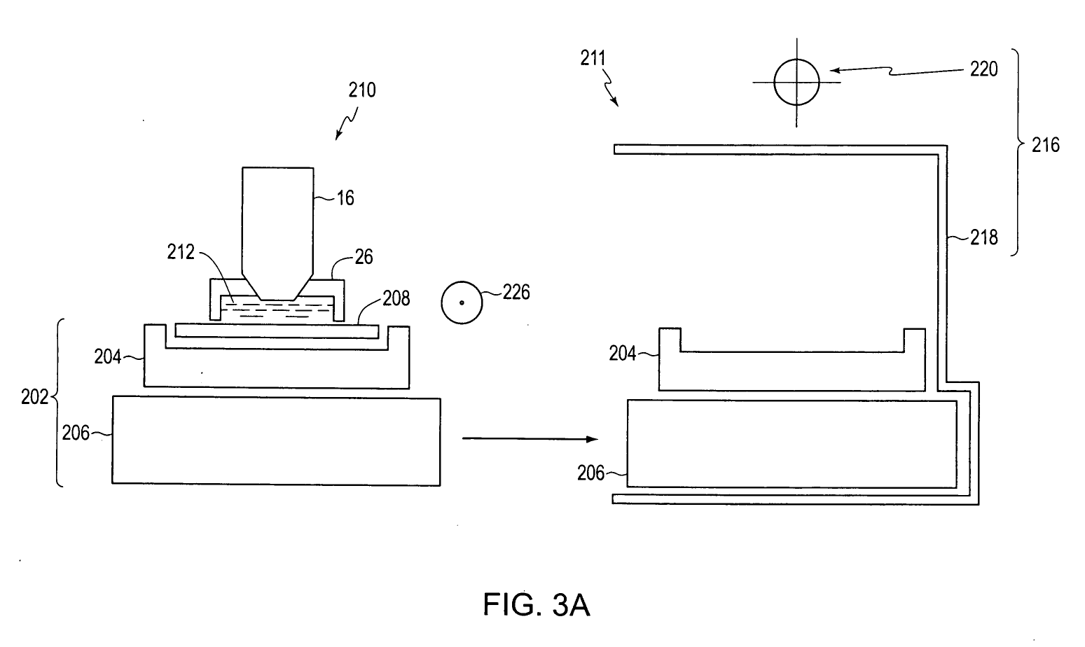

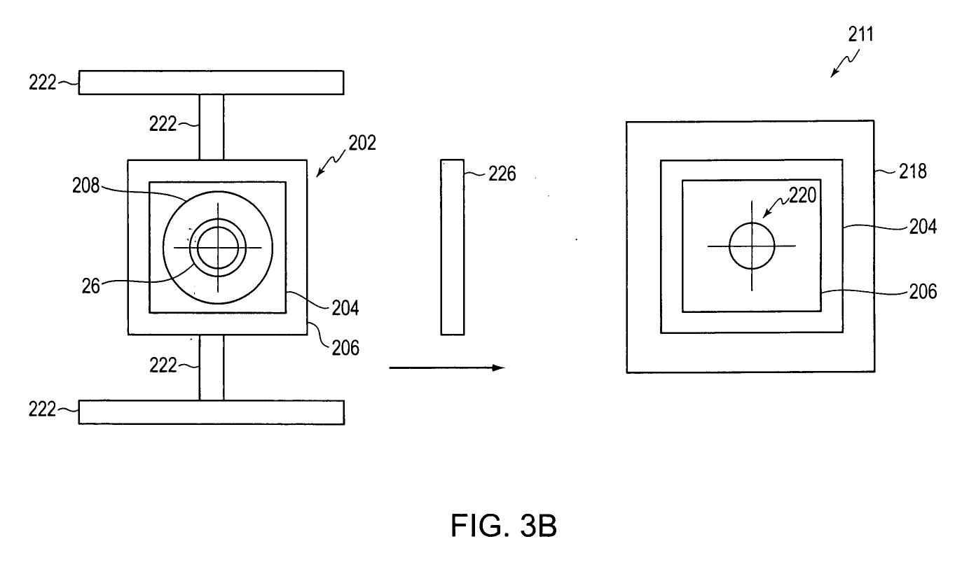

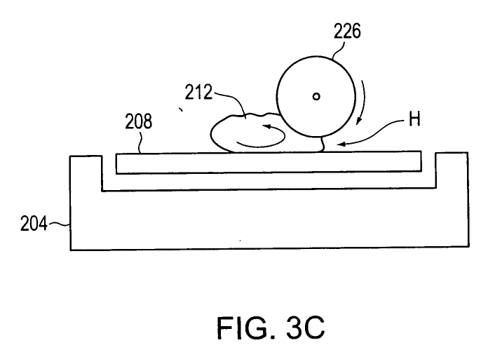

Referring to FIGS. 3A and 3B, a cross section and a plan (overhead) view of an immersion lithography machine illustrating another embodiment are shown. The lithography machine includes an optical assembly 16 disposed at a first station 210. The lithography machine also includes a stage assembly 202 that includes a workpiece table 204 and a wafer stage 206. The workpiece table 204 is configured to support a workpiece 208 (wafer or any other type of substrate) under the optical assembly 16. An environmental system 26, surrounding the optical assembly 16, is used to supply and remove immersion fluid 212 from the space between the workpiece 208 and the lowermost optical element of the optical assembly 16. The immersion lithography machine also includes a second station 211. The second station 211 includes a workpiece exchange system 216, including a workpiece loader 218 (i.e., a robot) and an alignment tool 220 (for example, a microscope and CCD camera), that is configured to remove the workpiece 208 on the workpiece table 204 and replace it with a second workpiece. This is typically accomplished using the workpiece loader 218 to remove the workpiece 208 from the workpiece table 204. Subsequently, the second workpiece (not shown) is placed onto the workpiece loader 218, aligned using the alignment tool 220, and then positioned under the optical assembly 16 on the workpiece table 204. As illustrated in FIG. 3B, motors 222 are used to move the stage assembly 202 including the workpiece table 204 and workpiece stage 206 in up to six degrees of freedom (X, Y, Z, θ_{X}, θ_{y}, θ_{z}) during operation. The motors 222 can be any type of motors, such as linear motors, rotary motors, voice coil motors, etc.

The lithography machine includes a rotating cylinder 226 disposed between the first station 210 and the second station 211. The rotating cylinder 226 is configured to remove the immersion liquid 212 left on the workpiece 208 and/or workpiece table 204 during workpiece exchange and/or during long fast moves of the stage assembly 202 from the first station 210 to the second station 211 so that these operations can be carried out without scattering liquid droplets. At least during exposure, immersion liquid 212 is continuously supplied by an immersion liquid supply element (not shown) of the environmental system 26 disposed around the last optical element of the optical assembly 16, and is continuously recovered through a recovery element (not shown) of the environmental system 26. After processing at station 210 is completed, according to some embodiments, liquid is removed from environmental system 26. Alternatively, liquid could be maintained adjacent to the optical assembly (e.g., with a cap or shutter), while liquid is removed from the workpiece 208. In order to perform a workpiece exchange, the workpiece table 204 moves from the first station 210 to the second station 211 by moving from left-to-right in FIGS. 3A and 3B. This movement is performed as rapidly as possible to maintain a high throughput. However, as discussed above, there is some immersion liquid 212 remaining on the workpiece 208 and/or the upper surface of the workpiece table 204. FIG. 3C illustrates an example of how the rotating cylinder 226 removes immersion liquid 212 left on a surface of the workpiece 208 and/or workpiece table 204 during workpiece exchange and/or during long fast moves of the stage assembly 202 from the first station 210 to the second station 211.

Specifically, FIG. 3C illustrates what happens when the immersion liquid 212 on a surface of the workpiece 208 and/or workpiece table 204 contacts the rotating cylinder 226. As shown in FIG. 3C, the surface of the rotating cylinder 226 is spaced from the surface of the workpiece 208 by a small distance H. The distance H may typically range from 1 to 2 mm. However, the distance H may be as small as 300 μm. The rotating cylinder 226 rotates in a clockwise direction while the workpiece 208 is moved to the right. The rotation of the rotating cylinder 226 causes the immersion liquid 212 to flow in a direction opposite to the direction of movement of the workpiece 208 so that the immersion liquid 212 is removed from the workpiece 208 when the workpiece 208 passes under the rotating cylinder 226 as the workpiece 208 moves away from the optical assembly 16. Because no liquid droplets are left on the workpiece 208 and/or the workpiece table 204, no immersion liquid 212 will be scattered due to the movement of the workpiece table 204. Processes like workpiece alignment and workpiece unload/exchange can be performed at this time. After the new workpiece has been aligned using one or more alignment tools 220, the workpiece table 204 is repositioned under the optical assembly 16. Exposure is then performed. In this manner, the rotating cylinder 226 removes the immersion liquid 212 left on the workpiece 208 and/or workpiece table 204 during workpiece exchange and/or during long fast moves of the stage assembly 202 from the first station 210 to the second station 211.

In various embodiments, the surface of the rotating cylinder 226 is liquid-phyllic so that the immersion liquid 212 is attracted to the surface of the rotating cylinder 226. Thus, the immersion liquid 212 is picked up by the rotating cylinder 226. In further embodiments, the rotating cylinder 226 comprises a porous medium so as to absorb immersion liquid 212 that is picked up by the surface of the rotating cylinder 226. In various embodiments, there may be provided a low pressure vacuum (not shown) connected to the rotating cylinder 226 that removes immersion liquid 212 absorbed by the rotating cylinder 226. The cylinder preferably has a length (in the direction of its rotation axis) that is at least as long as the dimension of the workpiece in the direction perpendicular to the movement direction between the first and second stations. For example, if the workpiece 208 is circular, the length of the rotating cylinder 226 preferably is at least as great as a diameter of the workpiece 208. Even more preferably, the length of the rotating cylinder 226 preferably is at least as great as the dimension of the workpiece table 204 in the direction perpendicular to the movement direction between the two stations.

In various embodiments, a control system (not shown) may control vertical position and/or tilt of at least one of the workpiece table 204 and the rotating cylinder 226 so as to adjust the workpiece table 204 and/or the rotating cylinder 226 as needed before, during or after the workpiece table 204 is moved out from under the optical assembly 16. Further, the operation that is performed when the workpiece table 204 is away from the optical assembly 16 is not limited to a workpiece exchange operation. For example, an alignment operation, a measurement operation or other operations that involve long fast moves of the workpiece 208 or the workpiece table 204 may be executed while removing the immersion liquid 212 from the workpiece 208 and/or workpiece table 204.

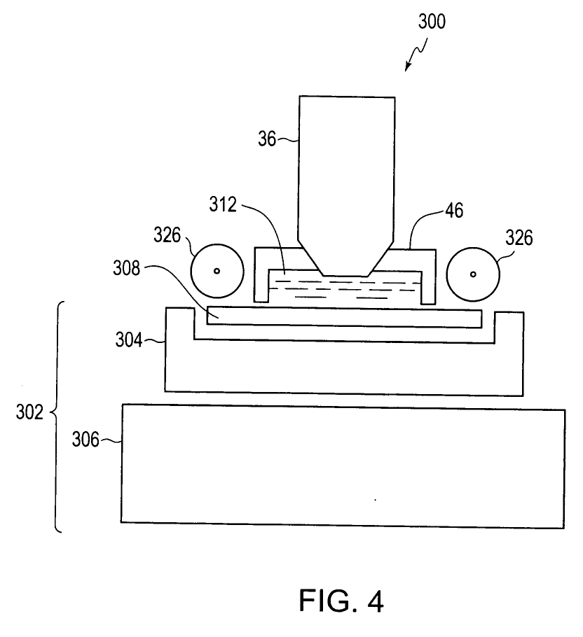

FIG. 4 illustrates an immersion lithography machine according to a further embodiment. The embodiment of FIG. 4 includes an immersion lithography machine 300 that is similar to the immersion lithography machine described with respect to FIGS. 3A and 3B. That is, the immersion lithography machine 300 includes an optical assembly 36 disposed at a first station. The machine 300 also includes a stage assembly 302 that includes a workpiece table 304 and a wafer stage 306. The workpiece table 304 is configured to support a workpiece 308 (wafer or any other type of substrate) under the optical assembly 36. An environmental system 46, surrounding the optical assembly 36, is used to supply and remove immersion fluid 312 from the space between the workpiece 308 and the lowermost optical element of the optical assembly 36. The immersion lithography machine 300 includes a plurality of rotating cylinders 326 collectively surrounding the space between the workpiece 308 and the lowermost optical element of the optical assembly 36 so as to keep the immersion liquid 312 from escaping from the space during exposure operations. For example, multiple rotating cylinders 326 could be placed around the perimeter of the environmental system 46. The rotating cylinders 326 may be made from the same materials (and may be supplied with a low pressure to remove collected liquid) as the rotating cylinder 226 described above with respect to FIGS. 3A and 3B. However, the length of each cylinder 326 could be less than the length of the cylinder 226 such that cylinders 326 collectively surround the environmental system 46, rather than the entire workpiece 308 or workpiece table 304.

It should be noted that although the problem of liquid droplets is described in the context of wafer exchange, it should be understood that different embodiments of the present disclosure could be used to remove liquid droplets regardless of how the liquid droplets end up on the wafer. For example, the liquid droplets could be removed during exposure.

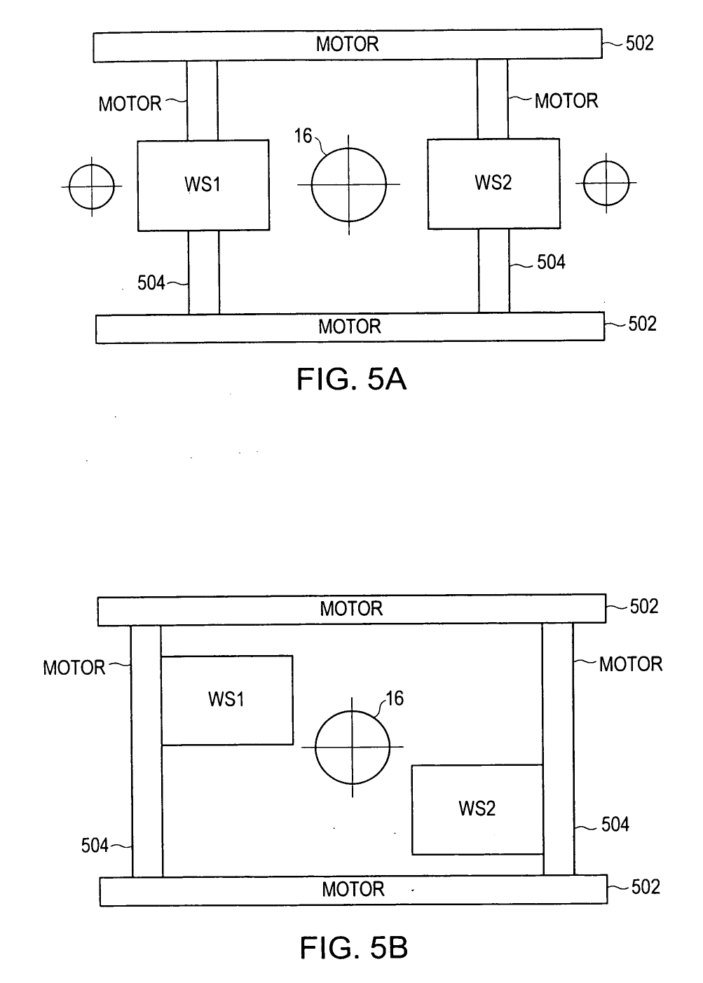

FIGS. 5A and 5B are plan views of two different twin stage immersion lithography systems according to other embodiments of the present invention. For the basic structure and operation of the twin stage lithography systems, see U.S. Pat. No. 6,262,796 and U.S. Pat. No. 6,341,007. The disclosures of U.S. Pat. No. 6,262,796 and U.S. Pat. No. 6,341,007 are incorporated herein by reference in their entireties. In both embodiments, a pair of workpiece stages WS1 and WS2 is shown. Motors 502 are used to move or position the two stages WS1 and WS2 in the horizontal direction (in the drawings), whereas motors 504 are used to move or position the stages WS1 and WS2 in the vertical direction (in the drawings). The motors 502 and 504 are used to alternatively position one stage under the optical assembly 16 while a workpiece exchange and alignment is performed on the other stage. When the exposure of the workpiece under the optical assembly 16 is complete, then the two stages are swapped and the above process is repeated. With either configuration, the various embodiments of the invention for removing liquid from the workpiece or the workpiece table as described and illustrated above with regard to FIGS. 2A through 4, can be used. With regard to the embodiments of FIGS. 2A and 2B and 3A and 3B for example, a porous member 126 and rotating cylinder 226, respectively, could be used between a first station (the location of the optical assembly 16) and one or both of second stations (the locations of alignment devices and/or workpiece exchange devices). During the time when stages WS1 and WS2 are to be swapped, the porous member 126 or the rotating cylinder member 226 removes liquid from the workpiece and/or the workpiece table. In the embodiment of FIG. 4, during the time when stages WS1 and WS2 are to be swapped, the rotating cylinders 326 keep the immersion liquid 312 from escaping from the space between the optical assembly 36 and the workpiece 308.

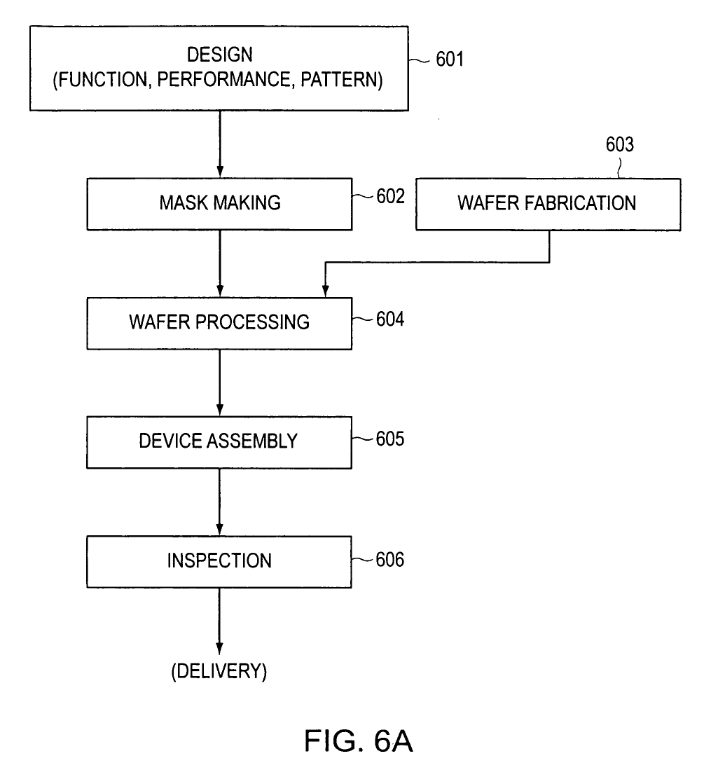

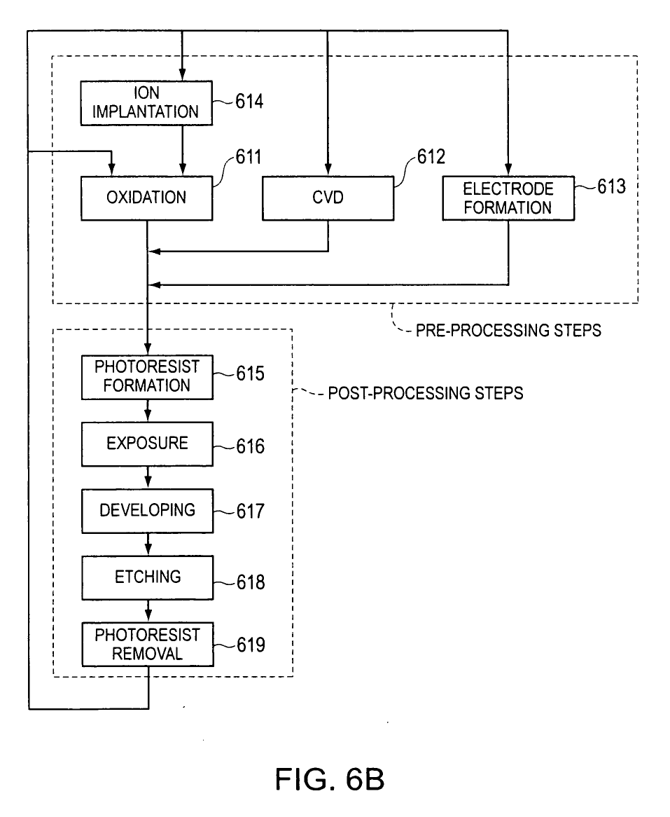

Workpieces, such as semiconductor wafers, can be fabricated using the above described systems, by the process shown generally in FIG. 6A. In step 601 the substrate's function and performance characteristics are designed. Next, in step 602, a mask (reticle) having a pattern is designed according to the previous designing step, and in a parallel step 603 a workpiece is made from a silicon material. The mask pattern designed in step 602 is exposed onto the workpiece from step 603 in step 604 by a photolithography system described hereinabove in accordance with the various embodiments. In step 605 the workpiece is assembled (including the dicing process, bonding process and packaging process). Finally, the workpiece is then inspected in step 606.

FIG. 6B illustrates a detailed flowchart example of the above-mentioned step 504 in the case of fabricating workpieces such as semiconductor substrates. In FIG. 6B, in step 611 (oxidation step), the workpiece surface is oxidized. In step 612 (CVD step), an insulation film is formed on the workpiece surface. In step 613 (electrode formation step), electrodes are formed on the workpiece by vapor deposition. In step 614 (ion implantation step), ions are implanted in the workpiece. The above mentioned steps 611-614 form the preprocessing steps for workpieces during workpiece processing, and selection is made at each step according to processing requirements.

At each stage of workpiece processing, when the above-mentioned preprocessing steps have been completed, the following post-processing steps are implemented. During post-processing, first, in step 615 (photoresist formation step), photoresist is applied to a workpiece. Next, in step 616 (exposure step), the above-mentioned exposure substrate is used to transfer the circuit pattern of a mask (reticle) to a workpiece. Then in step 617 (developing step), the exposed workpiece is developed, and in step 618 (etching step), parts other than residual photoresist (exposed material surface) are removed by etching. In step 619 (photoresist removal step), unnecessary photoresist remaining after etching is removed.

Multiple circuit patterns are formed by repetition of these preprocessing and post-processing steps.

While the particular lithography machines as shown and disclosed herein are obtaining the objects and providing the advantages herein before stated, it is d that they are merely illustrative embodiments of the invention, and that the limited to these embodiments.

What is claimed is:

1. A system comprising:
a first station at which a workpiece is subjected to processing that may leave a liquid on a surface of the workpiece;
a second station disposed at a location spaced apart from the first station; and
a porous member disposed between the first and second stations, the porous member having a liquid-phyllic surface that faces the workpiece and is spaced from a surface of the workpiece by a gap,
the porous member positioned adjacent the workpiece when the workpiece is moved from the first station to the second station, a length of the porous member being at least as large as a dimension of the workpiece in the direction perpendicular to the movement direction in which the workpiece moves.

2. The system of claim 1, further comprising a stage that holds the workpiece, the stage being movable between the first and second stations.

3. The system of claim 2, wherein the porous member length is at least as large as a dimension of an upper surface of the stage in the direction perpendicular to the movement direction.

4. The system of claim 1, wherein the workpiece is circular, and the porous member length is at least as great as a diameter of the workpiece.

5. The system of claim 1, wherein the gap is 1-2 mm.

6. The system of claim 1, wherein the porous member is stationary.

7. The system of claim 1, wherein the porous member rotates about its axis.

8. The system of claim 7, wherein a rotation direction of the porous member is such that a surface of the porous member facing the workpiece moves in a direction toward the first station as the workpiece moves from the first station toward the second station.

9. The system of claim 1, wherein the system is an immersion exposure apparatus that projects an image onto the workpiece through a projection system and an immersion liquid, the projection system disposed at the first station.

10. The system of claim 1, wherein the porous member length is a length in the direction perpendicular to the movement direction.

11. A lithographic projection apparatus comprising:
an optical assembly that projects an image onto a workpiece;
a stage assembly including a workpiece table that supports the workpiece adjacent to the optical assembly;
an environmental system that supplies and removes immersion liquid to and from a space between the workpiece and the optical assembly;
a workpiece exchange station that is disposed at a location that is spaced away from the optical assembly; and
a rotating cylinder having a liquid-phyllic surface disposed in a path of movement of the stage assembly between the optical assembly and the workpiece exchange station, wherein
the rotating cylinder removes immersion liquid from a surface of the workpiece by rotating in a direction opposite to a direction of movement of the stage assembly when the stage assembly is moved from being disposed adjacent to the optical assembly towards the workpiece exchange station.

12. The apparatus of claim 11, wherein a distance between the workpiece and the rotating cylinder when the rotating cylinder is above the workpiece from 300 μm to 2 mm.

13. The apparatus of claim 11, wherein the rotating cylinder comprises a porous medium so as to absorb immersion liquid that contacts a surface of the rotating cylinder.

14. The apparatus of claim 13, further comprising a low pressure vacuum connected to the rotating cylinder that removes immersion liquid absorbed by the rotating cylinder.

15. The apparatus of claim 11, wherein a length of the rotating cylinder along the rotation axis of the rotating cylinder is at least as large as a dimension of an upper surface of the stage assembly.

16. The apparatus of claim 11, wherein the workpiece is circular, and a length of the rotating cylinder along the rotation axis of the rotating cylinder is at least as great as a diameter of the workpiece.

17. A lithographic projection apparatus comprising:
an optical assembly that projects an image onto a workpiece;
a stage assembly including a workpiece table that supports the workpiece adjacent to the optical assembly;
an environmental system that supplies and removes immersion liquid to and from a space between the workpiece and the optical assembly;
a workpiece exchange station that is disposed at a location that is spaced away from the optical assembly; and
a porous medium disposed in a path of movement of the stage assembly between the optical assembly and the workpiece exchange station, wherein
the porous medium absorbs immersion liquid from a surface of the workpiece when the immersion liquid contacts the porous medium when the stage assembly is moved from being disposed adjacent to the optical assembly towards the workpiece exchange station.

18. The apparatus of claim 17, wherein a distance between the workpiece and the porous medium when the porous medium is above the workpiece is between 300 μm and 2 mm.

19. The apparatus of claim 17, wherein a surface of the porous medium is liquid-phyllic.

20. The apparatus of claim 17, wherein the porous medium is ceramic.

21. The apparatus of claim 17, further comprising a low pressure vacuum connected to the porous medium to that remove immersion liquid absorbed by the porous medium.

22. A workpiece processing method comprising:
processing the workpiece at a first station at which a liquid may be left on a surface of the workpiece;
moving the processed workpiece from the first station toward a second station disposed at a location spaced apart from the first station; and
removing the liquid left on the workpiece as the workpiece moves toward the second station, the removing being performed by a porous member disposed between the first and second stations, the porous member having a liquid-phyllic surface that faces the workpiece.

23. The method of claim 22, wherein the porous member is stationary.

24. The method of claim 22, further comprising rotating the porous member about its axis.

25. The method of claim 24, wherein the porous member has a length in a direction perpendicular to a direction in which the workpiece moves from the first station toward the second station that is at least as great as the workpiece dimension in the perpendicular direction.

26. A lithographic projection apparatus comprising:
an optical assembly that projects an image onto a workpiece;
a stage assembly including a workpiece table that supports the workpiece adjacent to the optical assembly;
an environmental system that supplies and removes immersion liquid to and from a space between the workpiece and the optical assembly; and
a plurality of rotating cylinders collectively surrounding the space so as to keep the immersion liquid from escaping from the space between the optical assembly and the workpiece during exposure operations.
